(19) United States
(12) Patent Application Publication
(10) Pub. No.: US 2008/0303245 A1
(43) Pub. Date: Dec. 11, 2008

(54) NANO-T diverse application lever guardrail ramp trailer

(76) Inventor: Leo Bryce Schraeder, Vero Beach, FL (US)

Correspondence Address: LEO BRYCE SCHRAEDER, 446 EUGENIA ROAD, VERO BEACH, FL, 32963, US

(21) Appl. No.: 11/811,007

(22) Filed: Jun. 8, 2007

(51) Int. Cl. B62D 63/06

(52) U.S. Cl. 280/400

(57) ABSTRACT

An improved vertically stow able modular multi-purpose trailer with a levered suspended ramp and detachable lever. The trailer includes a forward angle iron frame section with a platform planar deck covering the interior area of the frame and a rear hinge cross member, all supported by a square tubular composite trailer tongue/backbone which extends from in front of and the entire length of the forward angle iron frame section and connects with the rear hinge cross member. The trailer further includes a ramp rear angle iron frame section with a second platform planer deck, a forward integral hinge, and a rear lip. The trailer further includes a tubular lever section above and the length of the forward angle iron frame outlining the forward angle iron frame silhouette and a knee joint vertical post extending down at the rear. The trailer is adapted to be configured in a deployed configuration, wherein the forward section and rear section are longitudinally positioned and hinged at the hinge cross member, forming a larger platform planar deck with the upper tubular lever section hinged at the posts to the hinge cross member integral hinge and suspending the end of the ramp rear angle iron frame. The trailer is further adapted to be configured in a vertically stowed configuration, wherein the forward angle iron frame section and the tubular lever section and the ramp rear angle iron frame are configured about the hinge cross member, in a manner as a folded hand fan.

This application claims priority of provisional application No. 60/811,259 of Jun. 6, 2006.

### BACKGROUND

1. Field of Invention

This invention relates to utility, motorcycle, ATV, Jet Ski, and multi use trailers with ramps.

2. Description of Prior Art

Present art does not address the unfilled void in the market for less labor intensive assembly line manufacturing, simpler built for the average American design, utilization of materials for double duty, double duty operation, economical transport of trailer components for assembly at distribution and sales points, ability to paint in diverse colors upon demand, streamlined appearance, streamlined design, streamlined ramp, simple assembly methods with regular bolts and hand tools, and attractive design. Present art is generally uniform in design attributes, for example:

U.S. Pat. No. 4,659,100 complicates common present designs and adds cost to the manufacturing process by large amounts of welding, can not be transported to distribution centers unassembled, very heavy, impossible to paint before assembly, no integral ramp, not designed for assembly line manufacturing.

U.S. Pat. No. 3,746,195 complicates common present designs and adds cost to the manufacturing process by large amounts of welding, can not be transported to distribution centers unassembled, very heavy, impossible to paint before assembly, no integral ramp, not designed for assembly line manufacturing.

U.S. Pat. No. 6,840,543 complicates common present designs and adds cost to the manufacturing process by using large amounts of welding, difficult to use, can not be transported to distribution centers unassembled, very heavy, impossible to paint before assembly, no integral ramp, not designed for assembly line manufacturing, and requires very specialized components.

U.S. Pat. No. 6,733,219 is simple in design but moving motorized vehicles up the ramp and parking can be difficult and dangerous, adds cost to the manufacturing process by using large amounts of welding, can not be transported to distribution centers unassembled, very heavy, impossible to paint before assembly, no integral ramp, not designed for assembly line manufacturing.

U.S. Pat. No. 5,340,145 is relatively simple but adds cost to the manufacturing process by using large amounts of welding, can not be transported to distribution centers unassembled, very heavy, impossible to paint before assembly, no integral ramp, not designed for assembly line manufacturing.

USPTO Patent Applications 20050236814 is complex; adds cost to the manufacturing process by using large amounts of welding, can not be transported to distribution centers unassembled, impossible to paint before assembly, no integral ramp, not designed for assembly line manufacturing.

USPTO Patent Applications 20010033066 is complex and uses specialized components, adds cost to the manufacturing process by using large amounts of welding, can not be transported to distribution centers unassembled, impossible to paint before assembly, not designed for assembly line manufacturing.

USPTO Patent Applications 20050184485 is complex and uses specialized components, adds cost to the manufacturing process by using large amounts of welding, can not be transported to distribution centers unassembled, impossible to paint before assembly, no integral ramp, not designed for assembly line manufacturing.

### OBJECTS AND ADVANTAGES

Prior art has ignored the market for mass produced product, easily acquired simple clean and neat trailer design. Instead prior art has relied heavily on welding and welded finished product, which must be shipped as such. Prior art has also relied heavily upon designs using cantilevered structure and special components and common practice. Accordingly several objects and advantages of my invention are:

(1) Directed to a trailer, which can be mass produced in assembly line and shipped disassembled for U.S. and world consumption.

(2) Compete head to head with large numbers of small local machine manufacturing companies.

(3) Manufactured with a majority of off the shelf materials.

(4) Simple tooling and low amounts of welding for manufacturing.

(5) Optimization of all construction materials used.

(6) Convert the guardrail of most common trailers into an economical double use.

(7) Convert the guardrail to interact with the ramp for leverage into an economical double use.

(8) Guardrail can be used for multiple optional uses.

(9) Integrate the ramp into streamlined usable deck.

(10) Suspend rather than cantilever the ramp.

(11) Unique style to attract customers.

(12) Follow in the steps of Henry Ford in making a unique product the average man can buy.

Still further objects and advantages will become apparent from a consideration of the ensuing description and drawings.

### DRAWING FIGURES

The present invention is described in the detailed description that follows, by reference to the noted drawings by way of non-limiting examples of preferred embodiments of the present invention, in which like reference numerals represent similar parts throughout several views of the drawings, and in which:

FIG. 1 is a rear backside overhead perspective view of the first exemplary embodiment depicting the Nano-T trailer.

FIG. 2 is a rear backside overhead perspective view of the first embodiment depicting the Nano-T trailer without tread brite aluminum (24), according to an aspect of the present invention.

FIG. 3 is a rear backside overhead perspective view of the forward frame (X) of the first embodiment, encompassed by the exploded forward frame components and exploded views, according to an aspect of the present invention.

FIG. 3a is a rear backside overhead perspective exploded view of the forward frame left integral hinge of the first embodiment, according to and aspect of the present invention.

FIG. 3b is a rear backside overhead perspective exploded view of the left forward frame dual hole plate and left front forward frame of the first embodiment, according to and aspect of the present invention.

FIG. 3c is a rear backside overhead perspective exploded cutout view of the rear tongue/backbone connection with the hinge cross member of the first embodiment, according to and aspect of the present invention.

FIG. 3d is a rear backside overhead perspective exploded view of the forward frame's tongue/backbone connection of the first embodiment, according to and aspect of the present invention.

FIG. 3e is a rear backside overhead perspective exploded view of the forward frame tongue/backbone and wood insert of the first embodiment, according to and aspect of the present invention.

FIG. 4 is a rear backside overhead perspective view of the lever guardrail ramp (Y) of the first embodiment, encompassed by the exploded guardrail ramp components and exploded views, according to an aspect of the present invention.

FIG. 4a is a rear backside overhead perspective exploded view of the lever guard rail ramp right knee joint and right post of the first embodiment, according to and aspect of the present invention.

FIG. 4b is a rear backside overhead perspective exploded view of the lever guard rail ramp safety mount and lever handle of the first embodiment, according to and aspect of the present invention.

FIG. 4c is a rear backside overhead perspective exploded view of the lever guardrail ramp right knee joint of the first embodiment, according to and aspect of the present invention.

FIG. 5 is a rear backside overhead perspective view of the first embodiment of a Nano-T trailer forward frame (X) and lever guard rail ramp (Y) assembled at point (Z) and left integral hinge (Z1a) and right integral hinge (Z2a), with left and right hinge bolts Z1 and z2, according to an aspect of the present invention.

FIG. 5a is a rear backside overhead perspective exploded view of the first embodiment of a Nano-T trailer right knee joint post and right integral hinge, according to an aspect of the present invention.

FIG. 6 is a left side perspective view of the first embodiment of a Nano-T trailer showing the humpback design of the guardrail ramp, according to an aspect of the present invention.

FIG. 7 is an overhead perspective view of the first embodiment of a Nano-T trailer forward frame (X) and lever guardrail ramp (Y) assembled, according to an aspect of the present invention.

FIG. 7a is an overhead perspective exploded view of the first embodiment of a Nano-T trailer point Z, according to an aspect of the present invention.

FIG. 8 is a left side perspective view of the first embodiment of a Nano-T trailer Torflex axle (26) and force distribution arrows, according to an aspect of the present invention.

FIG. 9 is a left side perspective view of the first embodiment of a Nano-T trailer leaf spring axle (27) and force distribution arrows, according to an aspect of the present invention.

FIG. 10 is a rear backside overhead perspective view of the Nano-T trailer components packaging, according to an aspect of the present invention.

FIG. 11 is a rear backside overhead perspective view of a one-piece forward frame of the first embodiment, according to an aspect of the present invention.

FIG. 12 is left side perspective views of the first embodiment and front perspective views of the first embodiment showing operation of the safety latch at point Z in conjunction with a safety latch bolt and lever guard rail ramp, according to an aspect of the present invention.

FIG. 13 is the front, left and right perspective views of the first exemplary embodiment of the safety latch and point Z of the Nano-T trailer.

FIG. 13a is the side perspective view of the safety latch bolt (1a).

FIG. 14 is a left side perspective sequential view of operation of the first embodiment, left side perspective view of the first embodiment in vertical position, and an underside view of the first embodiment in a vertical position, according to an aspect of the present invention.

FIG. 15 is left side perspective views of the first embodiment, lever guardrail ramp, and lever guardrail, and accessories and front perspective views of the first embodiment lever guardrail in vertical position, according to an aspect of the present invention.

FIG. 16 is a left side perspective view of the first embodiment of a Nano-T trailer in folded configuration, according to an aspect of the present invention.

FIG. 17 is a side perspective view of the first exemplary embodiment of a derivative of the Nano-T trailer without humpback and knee joint.

FIG. 18 is a side perspective view of the first exemplary embodiment of a derivative of the Nano-T trailer without humpback.

### SUMMARY

In accordance with the present invention the Nano-T is a utility trailer with; a lever guard rail ramp, lever safety latch, lever guard rail which can be converted for multiple uses, collapses for vertical storage, assembles from pre-painted modular components, available in any color or mixed variation, assembled by anyone with simple hand tools, can be ordered and assembled on the spot, specifically designed for mass production.

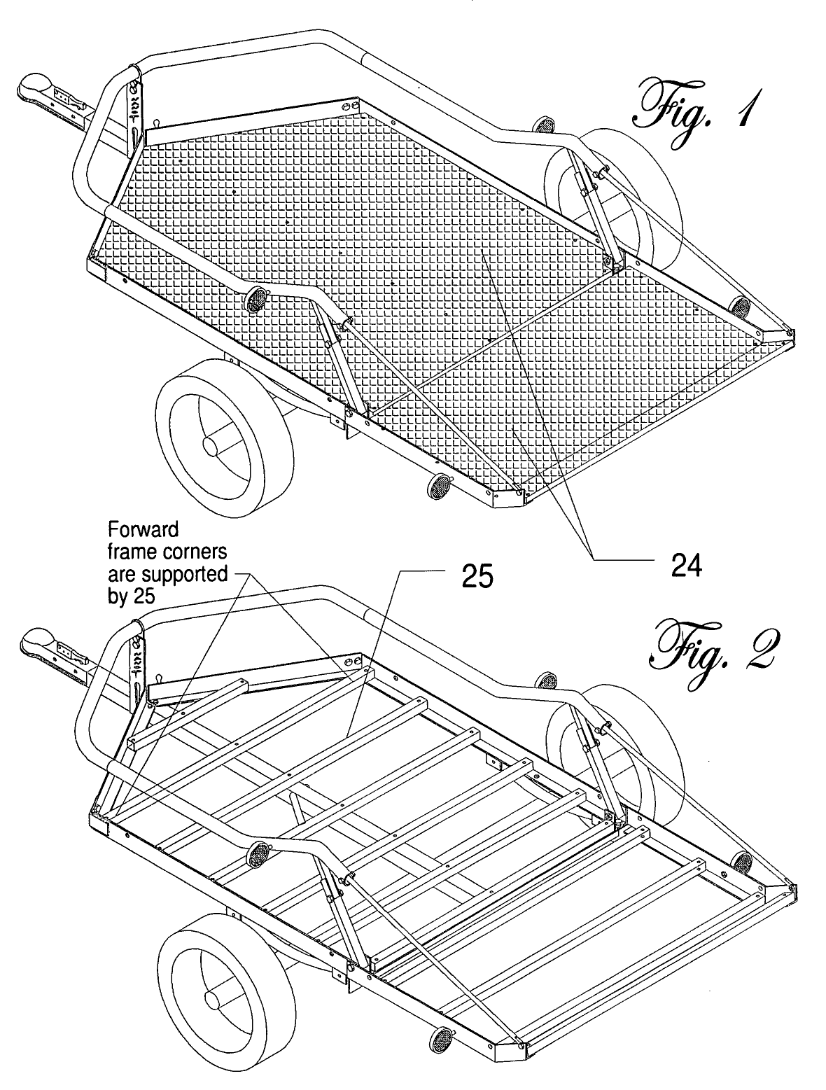

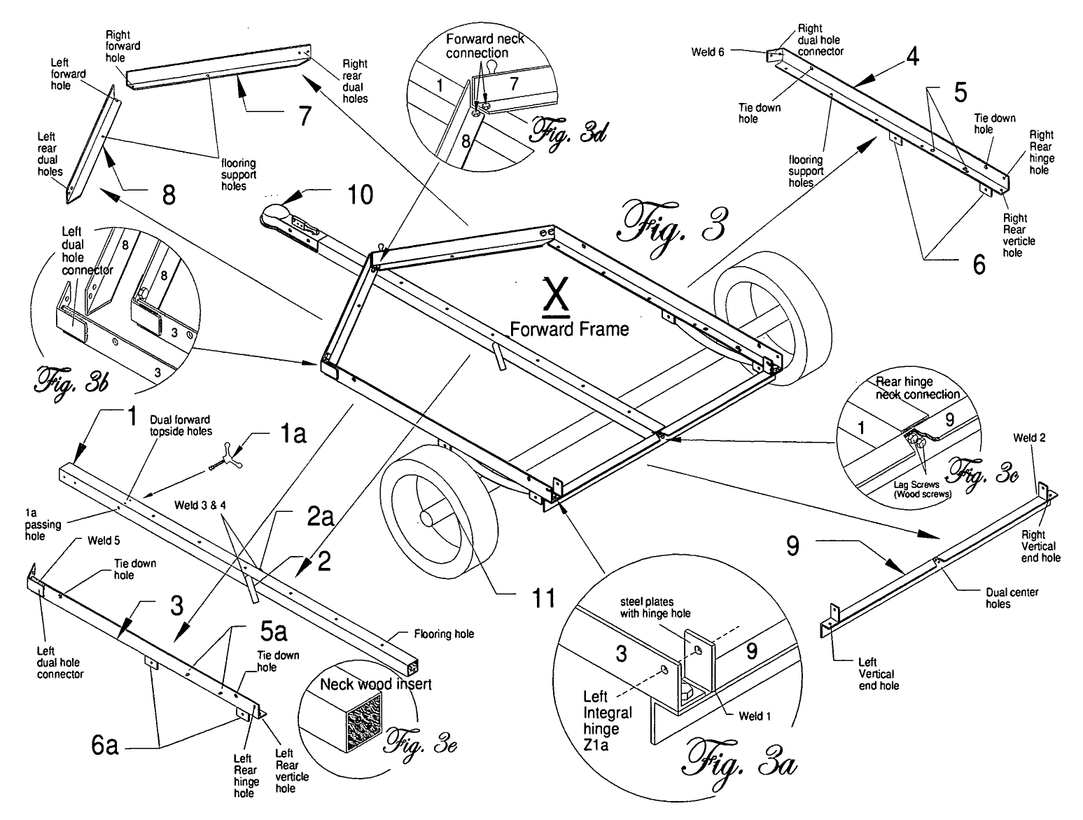

### DESCRIPTION-FIGS. 1 TO 16

Nano-T has a deployed configuration (see FIG. 1) and a folded, storable non-deployed configuration, which allows the Nano-T to be stored in a vertical upright position (see FIG. 14). The Nano-T may utilize a ramp operating in conjunction with the guardrail (see FIGS. 14, 15, 16) forming a lever guardrail ramp with a lever capacity of approximately 2:1 manually and enhanced lever force with addition of a hand winch. The Nano-T may utilize the guardrail lever detached from the ramp. A preferred embodiment of the Nano-T trailer may have a weight of about 350 lbs., may have a capacity of about 2,000 lbs., may have a deck area of about 57″×110″, may have a standing height of about 70″, may have width of about 72″, may have a depth of about 36″, and may have a length of about 130″.

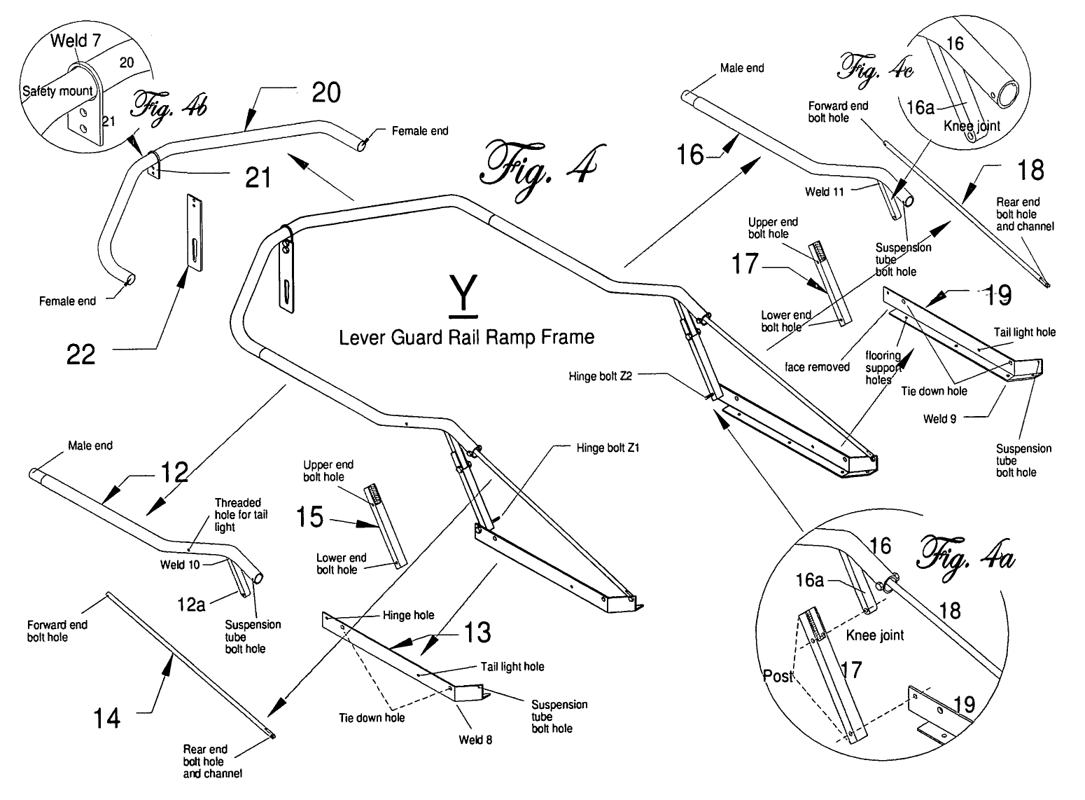

Nano-t is distinctly composed of the forward frame (X) assembled from modular components 1, 1a, 3, 4, 7, 8, 9, 10, 11 (see FIG. 3) and lever guard rail ramp Y assembled from modular components 12, 13, 14, 15, 16, 17, 18, 19, 20, 21, 22 (see FIG. 4).

### Forward Frame X Assembly Description

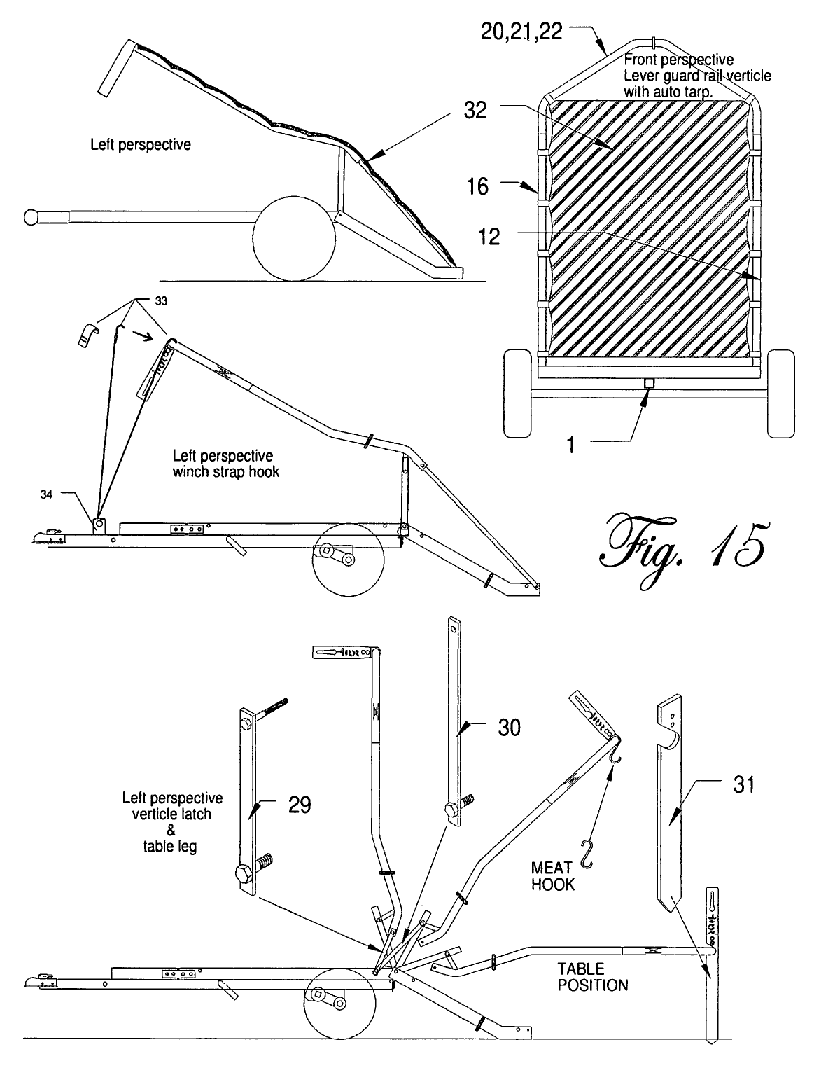

Forward Frame (X) begins assembly upon a right forward frame (3) and left forward frame (4) bolted to a Torflex axle (26) by holes (5), (5a) or bolted to a leaf spring axle (27) by common shackles holes (6), (6a) (see FIGS. 3, 8, 9). Rear hinge cross member (9) bolts by vertical end holes to rear vertical holes of right forward frame (3) and left forward frame (4) forming left integral hinge (Z1a) and right integral hinge (Z2a) (see FIGS. 3a, 3, 5, 5a) and bolts by dual center holes to tongue/backbone (1) using lag screws (wood screws) (see FIGS. 3c, 3). Right front forward frame (7) and left front forward frame (8) rear dual holes bolt to dual hole connectors of right forward frame (3) and left forward frame (4) (see FIGS. 3b, 3), right front forward frame (7) and left front forward frame (8) forward bolt holes bolt to tongue/backbone (1) dual forward topside holes using lag screws (wood screws) (FIGS. 3d, 3). Square steel tubing floor support (25) is fastened to the provided holes of the forward frame and tread brite aluminum sheet is positioned as flooring. Safety latch bolt (1a) assembles by threading part (1a2) through the horizontal 1a passing hole of tongue/backbone (1) and the stainless steel interior bolt (FIGS. 13, 1a3), threading on 1a1 and fixing with adhesive (see FIGS. 3, 5, 13, 13a), trailer hitch (10) is bolted to the front of tongue/backbone (1), thus forming unit Forward Frame (X).

### Forward Frame X Component Fabrication Description

Composite tongue/backbone (1) may be of but not limited to off the shelf 2½″×2½″×82″ ( 3/16″ wall) square steel tubing enclosing a solid wood insert (see side views of FIGS. 3e, 13). A corner of the solid wood insert is planed along the length to allow for a wire channel for passage of taillight wiring (see FIGS. 3e, 13). Composite tongue/backbone (1) is perforated for entry of lag screws (wood screws) for affixing floor support (25) and tread brite aluminum flooring (24), bolting on components 7, 8, 9, and 10 (see FIGS. 3c, 3d, 3), insertion of safety latch bolt (1a) (see FIGS. 3, 7, 13) (see FIG. 13). Composite tongue/backbone (1) left tube holder (2) right tube holder (2a) are welded on tubes of 4″ length positioned as and for entry of left suspension tube (14) and right suspension tube (18) when in vertical storage position (see FIG. 14).

Mirror image components right forward frame (3) and left forward frame (4) may be of but not limited to off the shelf 2″×3″×55″ ( 3/16″ wall) angle iron hole punched and angle cut to specs, may include optional Torflex axle (26) (http://i.b5z.net/i/u/1080235/f/6-8K %20Catalog/1000-2000_lbs_{—}80_res_{—}2-05.pdf) bolt holes (5), (5a) or may include common leaf spring axle (27) shackles (6), (6a) (see FIGS. 3, 8, 9), may have dual hole connectors for bolting right front forward frame (7) and left front forward frame (8) (See FIGS. 3b, 3), a rear vertical hole for bolting to rear hinge cross member (9) (see FIG. 3a), tie down holes are punched on the vertical leg of the angle iron and floor support (25) holes are punched on the horizontal leg, and the rear hinge hole is at a specific position for folding the ramp over the forward frame (X) without obstruction by floor support (25) or tread brite aluminum (24) or left post (15) and right post (17) (see FIGS. 3a, 16).

Mirror image right front forward frame (7) and left front forward frame (8) may be of but not limited to off the shelf 2″×3″×32″ ( 3/16″ wall) angle iron hole punched and angle cut to specs (see FIG. 3), tie down holes are punched on the vertical leg of the angle iron and floor support (25) holes are punched on the horizontal leg and one forward hole for bolting to tongue/backbone (1) (see FIG. 3d) and rear dual holes for bolting to right forward frame (3) and left forward frame (4) dual hole connectors (see FIG. 3b).

Rear hinge cross member (9) may be of but not limited to off the shelf 2″×3″×57″ ( 3/16″ wall) angle iron hole punched and angle cut to specs, one vertical hole on each end for bolting to right forward frame (3) and left forward frame (4) rear vertical holes, two perpendicular welded steel plates with specific position hinge hole for hinge bolts (Z1) and (Z2) respectively (see FIGS. 3, 3a), dual center holes for bolting the rear of the tongue/backbone (1) (see FIGS. 3c, 4).

### Lever Guard Rail Ramp Y Assembly Description

Lever Guard Rail Ramp (Y) begins assembly upon left post (15) and right post (17) lower end bolt holes held in place by hinge bolts (Z1) and (Z2) to left ramp frame (13) and right ramp frame (19) hinge holes, left post (15) and right post (17) upper holes bolted to left knee joint (12a) and right knee joint (16a) holes of left lever arm (12) and right lever arm (16) (see FIGS. 4a, 4). Left suspension tube (14) and right suspension tube (18) rear end holes bolted to suspension tube holes of left ramp frame (13) and right ramp frame (19) and left suspension tube (14) and right suspension tube (18) upper holes bolted to suspension tube holes of left lever arm (12) and right lever arm (16) (see FIGS. 4a, 4). Left lever arm (12) and right lever arm (16) forward male ends insert into lever handle (20) two female ends (see FIG. 4). Lever handle (20) receives welded on safety latch mount (21) and allows for bolting safety latch 22 onto part 20, 21 (see FIGS. 4b, 4) thus forming basic planar unit Lever Guard Rail Ramp (Y).

### Lever Guard Rail Ramp Y Component Fabrication Description

Mirror image left post (15) and right post (17) may be of but not limited to off the shelf 1½″×1½″×18″ (⅛″ wall) square steel tubing, a length of approximately 3.85″ cut out wall starting at the upper end and which is parallel to upper through holes, lower through hole is approximately ½″ from the lower end of each tube and the upper through hole is approximately 3½″ from the upper end (see FIGS. 4a, 4).

Mirror image left ramp frame (13) and right ramp frame (19) may be of but not limited to off the shelf 2″×3″×36″ ( 3/16″ wall) angle iron hole punched and angle cut to specs, a lower 2″ face section approximately 2½″ long starting on the forward end is removed, the rear end 3″ face is cut and may be welded or bolted in place to accomplish an approximate 30 degree upward bend (may vary depending on height of trailer from the ground and length of ramp), tail light and tie down and floor support (25) holes are punched and tread brite sheet is added as flooring, the hinge hole is at a specific height/position so as to fold the ramp over the forward frame (X) without obstruction by support floor (25) and tread brite aluminum (24) or left post (15) and right post (17) (see FIGS. 3a, 4).

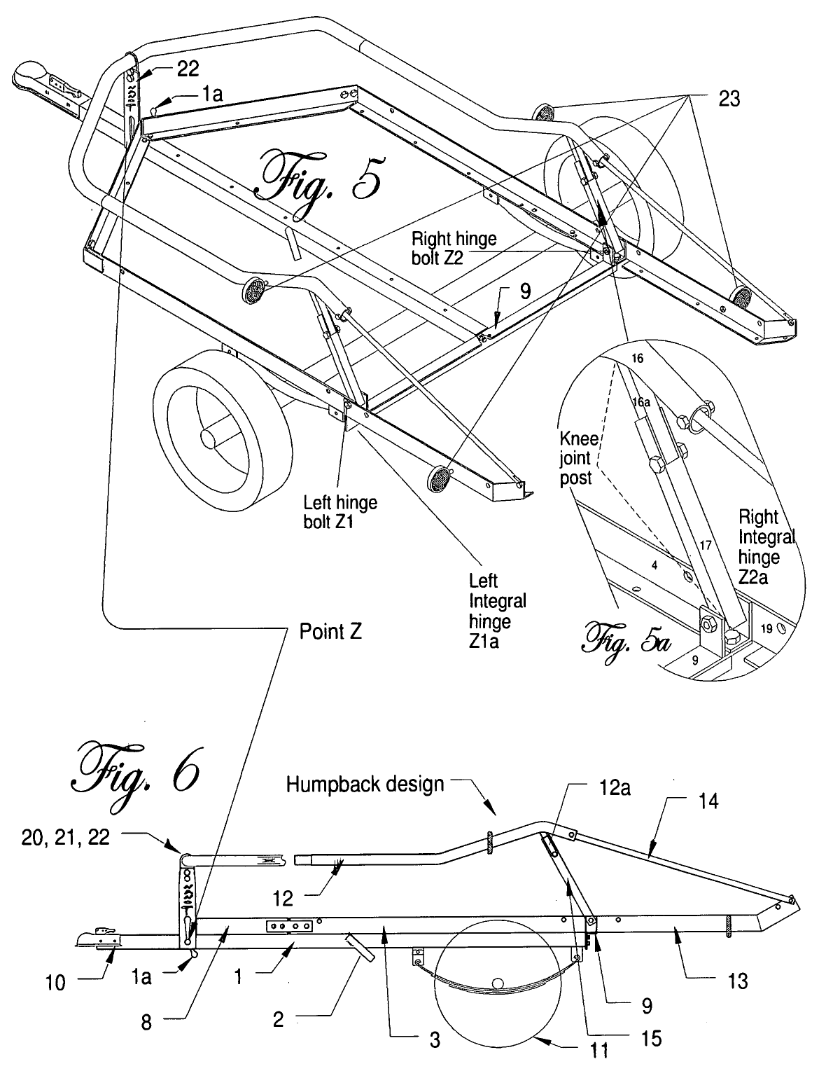

Mirror image left suspension tube (14) and right suspension tube (18) may be of but not limited to off the shelf tubing approximately 1″ outside diameter and approximately ⅞″ inside diameter and the forward end and rear end through bolt holes are at a distance to allow components 14 and 19 to set horizontally when bolted into deployed position, a center cut slot on the rear end to allow the tube to saddle the left ramp frame (13) and right ramp frame (19) when bolted on (see FIGS. 5, 6).

Mirror image left lever arm (12) and right lever arm (16) may be of but not limited to off the shelf 1½″ #40 steel pipe by approximately 52″ length, the front end is turned on a lathe and reduced in diameter approximately 0.214″ by approximately three inches length to form a male end, from the front end at an approximate distance of 25.5″ an approximately 17 degree 4″ radius upward bend and then at a distance of approximately 10″ a threaded hole is installed for installation of a tail light (23) and then at approximately 10.3″ is an approximate 34 degree 4″ radius downward bend in plane with the previous bend, at/on the bottom side crown of the second bend knee joints (12a) and respectively knee joint (16a) upper ends are centered on the pipe and welded at an angle of approximately 44 degrees in relation to the remaining straight pipe section end. Knee joint (12a) and knee joint (16a) may be of but not limited to off the shelf 1″×1″×5″ ( 3/16″ wall) square steel tubing, a through hole on the bottom end perpendicular to the lever arm length, bottom end rounded (see FIGS. 4c, 5, 6).

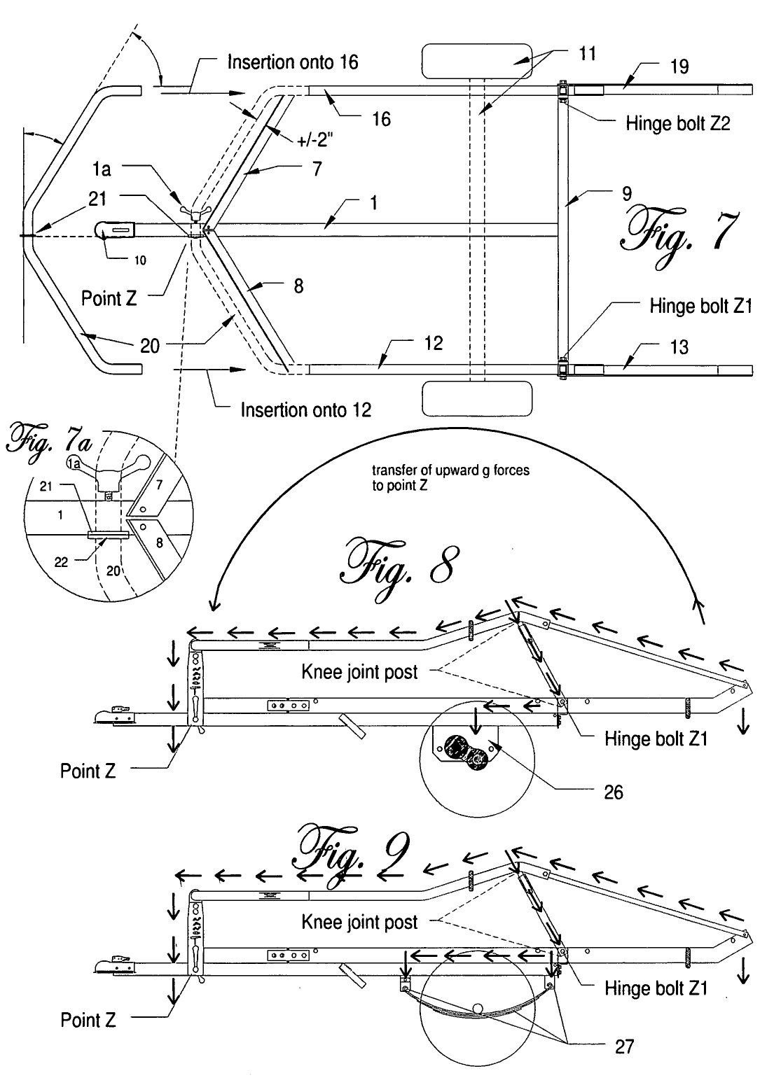

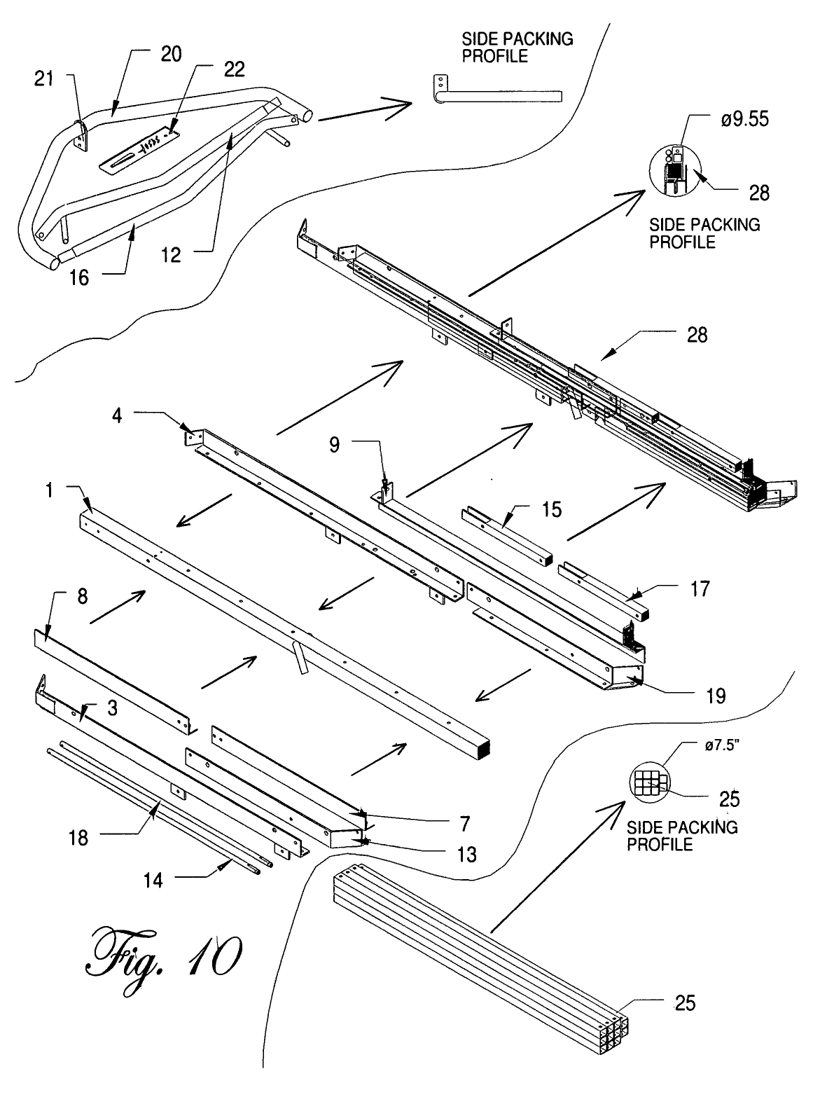

Lever handle (20) may be of but not limited to off the shelf 1½″ #10 steel pipe which is bent to follow the silhouette of the forward frame but extended, the bends are two mirror image bends in plane of approximately 32 degrees approximately 8″ apart from center and then two more mirror image bends in plane with the first two mirror image bends of approximately 57 degrees positioned to form up the remaining lengths center aligned with left lever arm (12) and right lever arm (16) male ends, lever handle (20) pipe ends are cut to length to obtain a position 2″ past the right and left front forward frame (7 & 8) when inserted into male ends of left lever arm (12) and right lever arm (16) (see FIG. 7). Safety mount (21) is slid onto lever handle (20) from either end and welded into position with the vertical outside face in line with vertical outside face of tongue/backbone (1) (see FIG. 13) and in line with the 1a passing hole of the tongue/backbone (1) (see FIGS. 3, 7, 7a, 13).

Safety mount (21) may be but not limited to being fabricated of plate stainless steel on a water jet cutting machine, made to slide onto lever handle (20) through the upper hole and then welded in position, two lower holes for connecting safety latch (22) (see FIG. 13).

Safety latch (22) may be but not limited to approximately a ¼″×3″×14½″ plate stainless steel cut on a water jet cutting machine, two upper bolt holes for bolting on to safety mount (21) which allow for adjusting safety latch (22) “Y” slot with the safety latch bolt (1a) on the tongue/backbone (1), the unique “Y” slot begins with an approximately 1″ diameter upper hole interrupted on the bottom side by slot sides that recede inward and downward and reduce in separation to a straight side channel of approximately ½″ and drop into a larger diameter hole (but lesser diameter than the upper hole) at the lower end, hole to hole distance is approximately four inches (see FIGS. 4b, 13).

Safety latch bolt (1a) may be but not limited to a threaded stainless steel shaft (1a2) approximately 2″ in diameter by approximately 5″ long with a shank (1a4) on one end of a larger diameter than the shaft but a fit for the lower hole of the “Y” slot and a bolt type head (1a5) at end next to the shank with a slightly lesser diameter than the upper hole of the “Y” slot, may use but not limited to an off the shelf aluminum ball handle nut (1a1) and interior stainless steel nut (1a3). The 1a3 nut is welded to the interior of the tongue/backbone at the 1a passing through hole which receive the safety latch bolt assembly (see FIGS. 3. 13).

### Forward Frame X and Lever Guard Rail Ramp Y Assembly

Forward Frame (X) and Lever Guard Rail Ramp (Y) unite at three points, left integral hinge (Z1a) and right integral hinge (Z2a) by hinge bolts (Z1) and (Z2) (see FIGS. 5, 5a), forward latch point Z by operation of tongue/backbone (1) and safety latch bolt (1a) and safety latch (22) (FIGS. 5, 13, 14).

### Nano-t Diverse Application Lever Ramp Trailer Operation

Nano-T modular components can all be assembled and packaged into three packages for shipping ground and air transport companies. Two packages may be but limited to less than 10″ in diameter and may be but not limited to no longer than 100″ and one package main body shipping profile (28) may be but not limited to 5″×24″×65″; (see FIG. 10).

Safety Latch (22) in conjunction with 1, 1a, 21 and 20 operate at point Z providing the double action safety catch and unlatch for unlatching the ramp. Safety latch (22) “Y” slot lower hole is latched by the shank (1a4) at point Z by a tightened aluminum ball handle nut (1a1), when aluminum ball handle nut (1a1) is loosened the shank (1a4) moves out of position and shaft (1a2) moves into position and allows “Y” slot to move down and stop catch at the top of the “Y” slot, to un-catch lever handle (20) must shift horizontally to the right approximately ½″-1″ thus pulling safety latch (22) over the head (1a5) of shaft (1a2) and unlatching. Manually pushing lever handle (20) down 4″ when unlatching forces a judgment call on the operator as to whether the weight can be handled without assistance, before, the latch is fully released (see FIGS. 12, 13).

Safety Latch (22) in conjunction with 1, 1a, 21, and 20 operate at point Z providing the double action safety catch and latch for latching the ramp. Lever handle (20) must shift to the right approximately ½″-1″ to allow access and entry of the “Y” slot upper large diameter hole of safety latch (22) over the un-tightened head (1a5) of safety latch bolt (1a) and onto shaft (1a2), lever handle (20) is manually released and gravity on the ramp pulls lever handle (20) and therefore safety latch (22) up through the “Y” slot to catch in the “Y” slot lower smaller diameter hole, aluminum ball handle nut (1a1) is tightened and shank (1a4) fixes in the lower diameter hole of safety latch (22) and is at latch at point Z. Manually lowering lever handle (20) and catching safety latch (22) on shaft (1a2) allows a temporary catch for the operator to leisurely tighten and complete the latch without concern of losing control due to gravity pulling on the ramp out of control (see FIGS. 12, 13).

Lever Guard Rail Ramp works very simply by the release of safety latch (22) from point Z and the movement upward (either by hand or winch) of the Lever Guard Rail Ramp (Y) so as to lower the Ramp to ground level. Cargo can then be placed on the lip of the ramp and or motorized vehicles can be loaded and the Lever Guard Rail is lowered (either by hand or winch) and the Ramp redeploys to horizontal position and safety latch (22) is latched again at point Z. The reverse is done for unloading (see FIG. 14).

Left suspension tube (14) and right suspension tube (18) can be removed from the Lever Guard Rail Ramp thus isolating the Lever Guard Rail from the Ramp. Thus the Lever Guard Rail can be lowered to the forward storage position by use of the knee joint and the Ramp can be swung up and over the back of the Lever Guard Rail and Nano-T can then be placed in vertical position and held in vertical position by left suspension tube (14) and right suspension tube (18) respectfully placed in left tube holder (2) and right tube holder (2a) on the bottom side of tongue/backbone (1). This configuration prevents the Nano-T from falling forward (see FIG. 14).

### Optional Components

Optionally Nano-T may use either the Torflex axle (26) http://i.b5z.net/i/u/1080235/f/6-8K %20Catalog/1000-2000_lbs_{—}80_res_{—}2-05.pdf) or a common leaf spring type axle (27) (see FIGS. 8, 9).

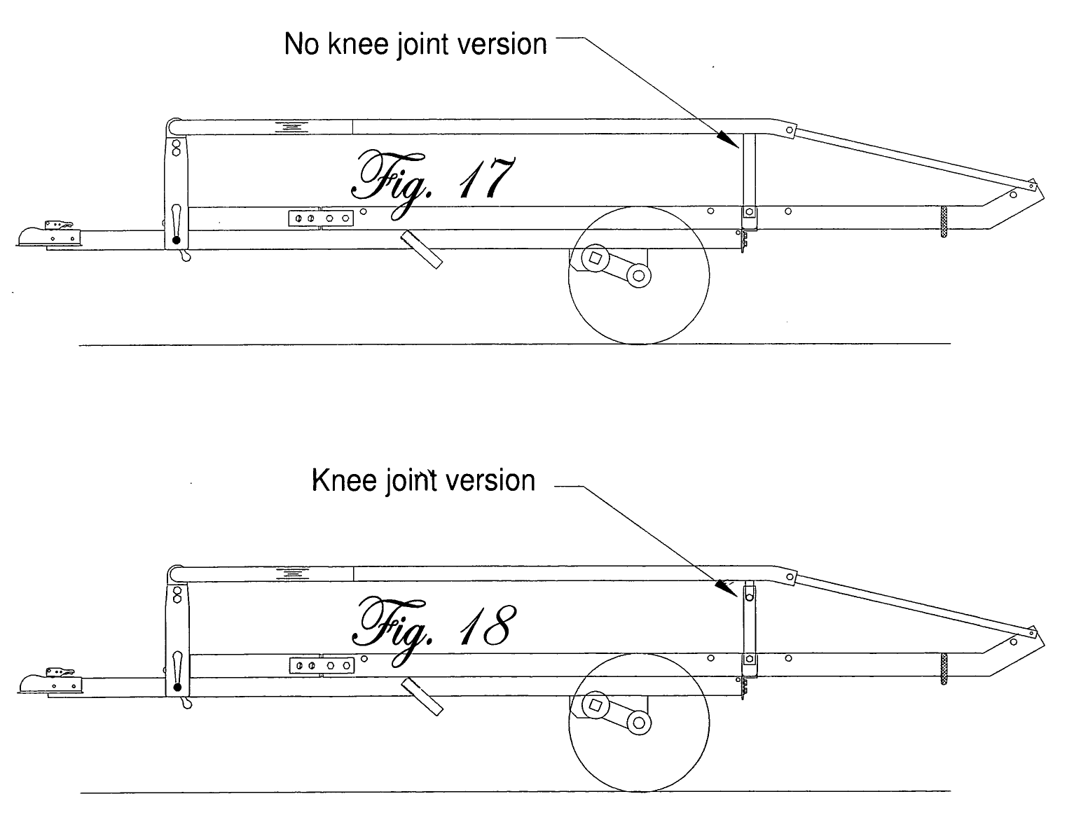

Optionally Nano-T Lever Guard Rail may be constructed in a derivative form in which left lever arm (12) and right lever arm (16) can accommodate the Nano-T without the bends (humpback) (see FIGS. 17, 18).

Optionally Nano-T Lever Guard Rail may be constructed without the Knee joint, which renders the Nano-T functional but eliminates the ability to lower the Lever Guard Rail for convenient vertical storage and the ramp cannot be rotated fully.

Optionally Nano-T floor support (25) may use but not limited to 1½″×1½″ ( 1/16″ wall) square steel tubing for the forward frame and the ramp, may us 2″×8″ boards, may use ¾″ thick plywood, the floor support (25) of the forward frame provides structural support and integrity mostly for the forward corners of the forward frame, since the floor support (25) and tread brite aluminum (24) are fastened to the components 1, 3, 4, 7, 8, 13, and 19 with holes at six inch spans; the ramp floor support (25) provides structural support and integrity to the ramp left ramp frame (13) and right ramp frame (19), since the floor support (25) is fastened at six inch span holes (see FIG. 1).

Optionally Nano-T tread brite aluminum (24) may be but not limited to 1/16″ thick tread brite aluminum over floor support (25) (see FIG. 1).

Optionally Nano-T may use either two or four tail lights (23).

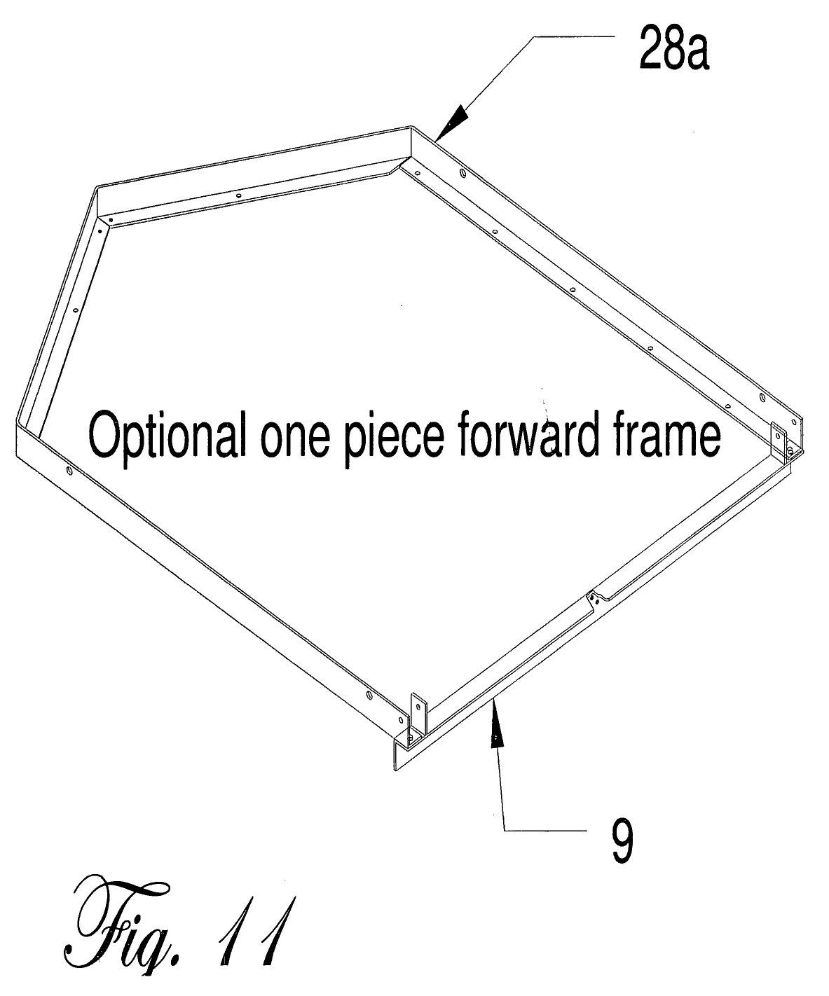

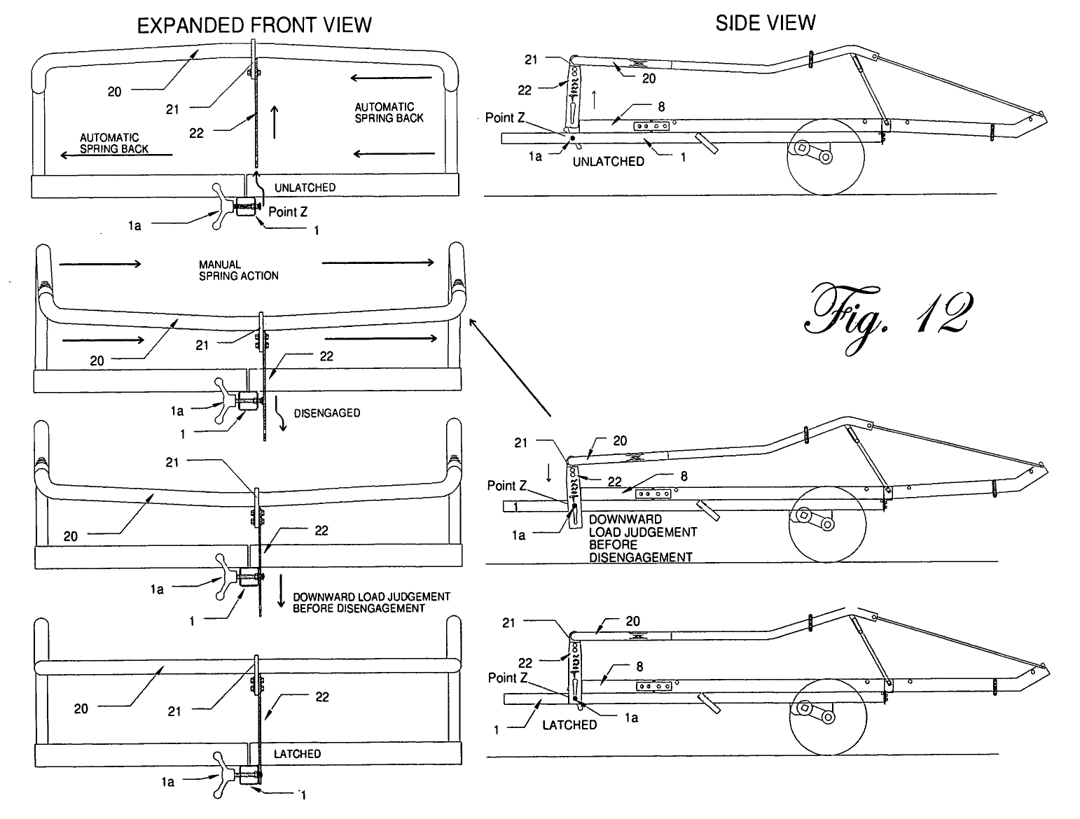

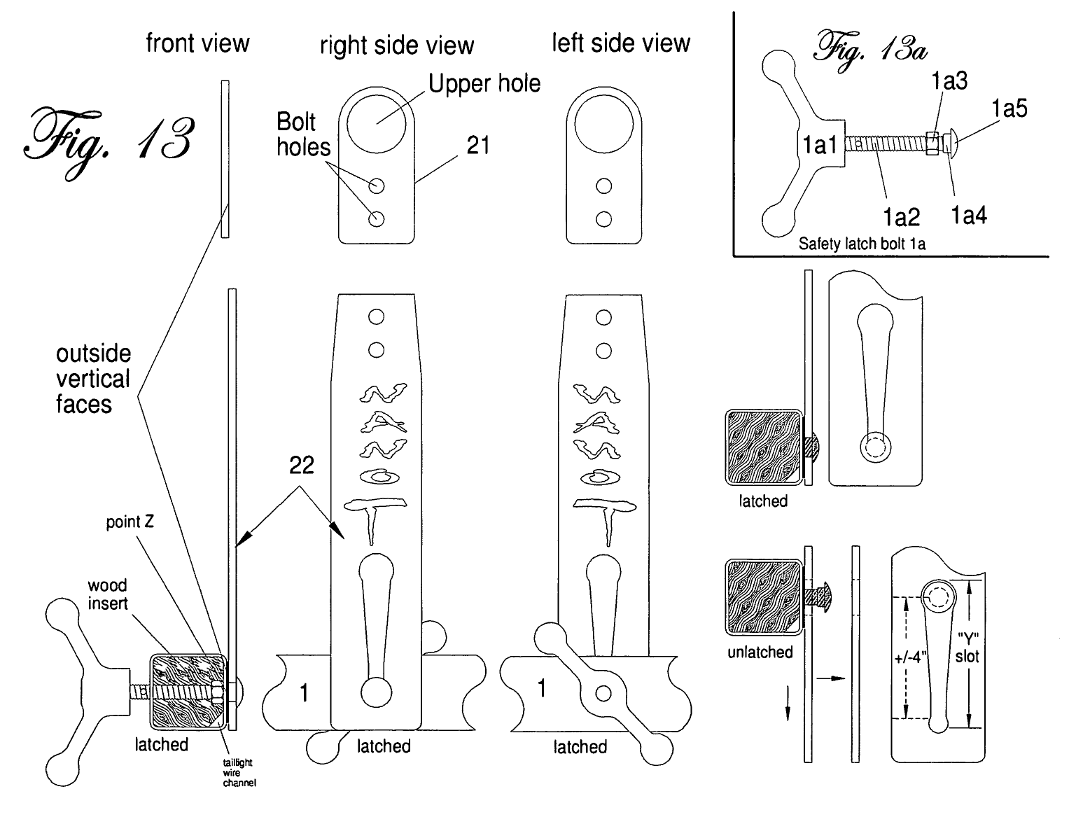

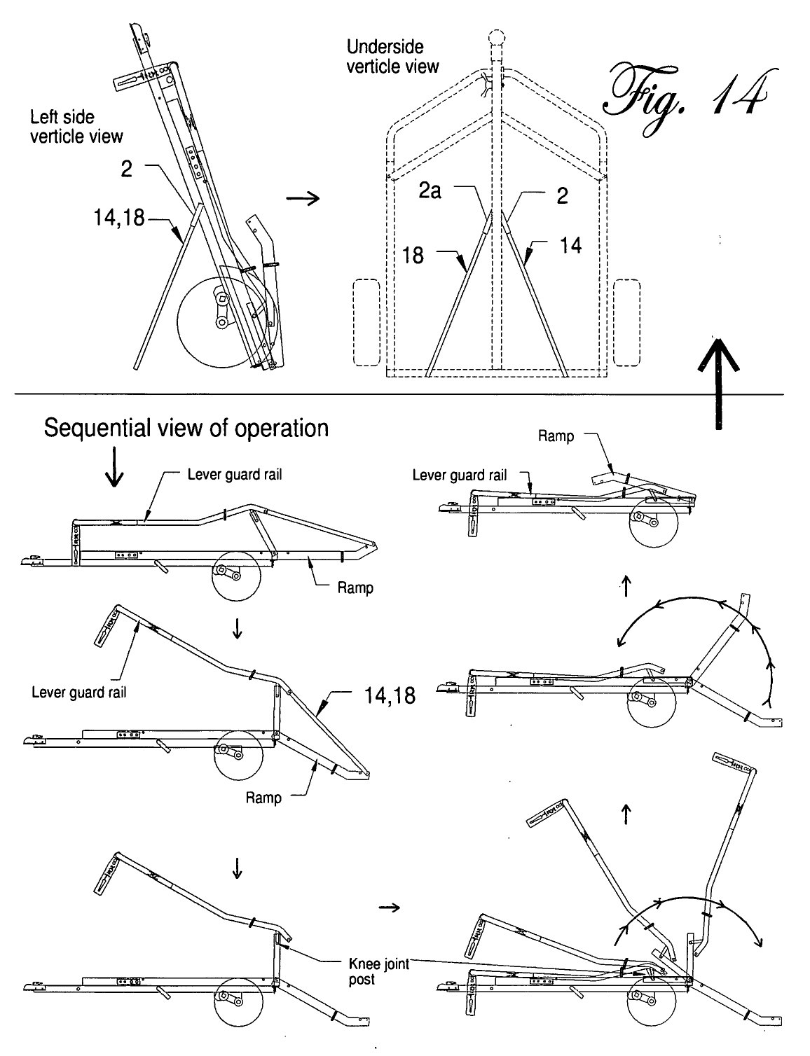

Optional one-piece forward frame (28a) may be but not limited to one piece 2″×3″×( 3/16″ wall) angle iron and replaces components 3, 4, 7, 8 (see FIG. 11). This component is used for point of sale locations where weight and size are not of importance in place of mail order or eBay type sales in which the unit has to be shipped and size and weight are of extreme importance as per price of shipping etc.

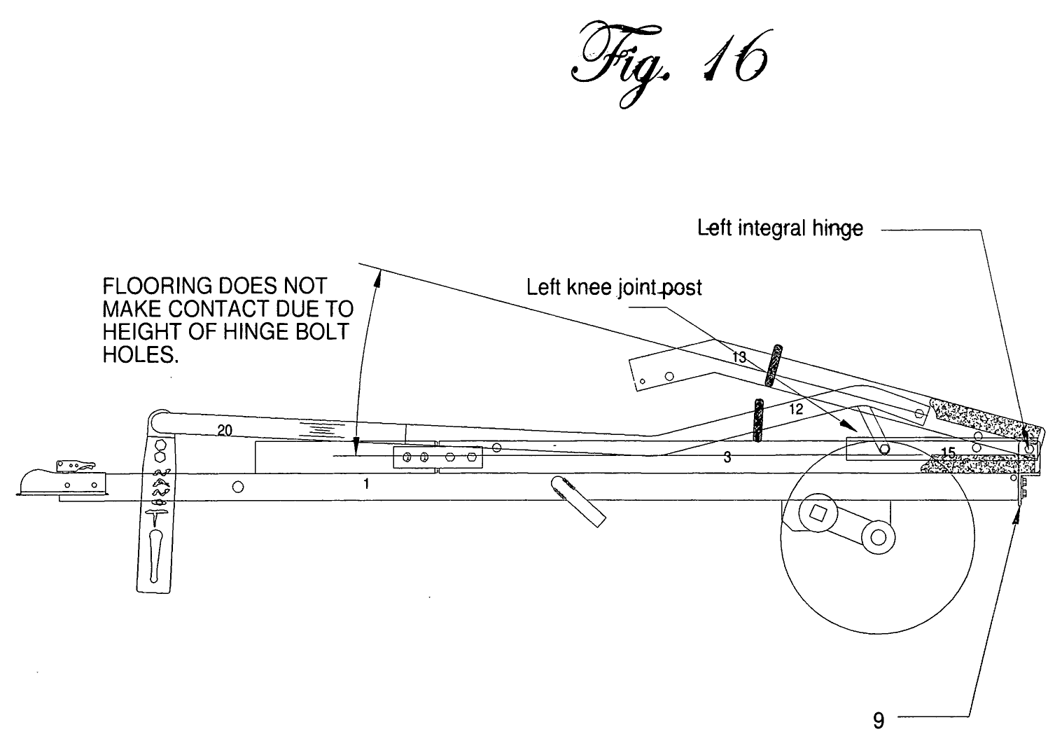

Optional winch (34) may be but not limited to off the shelf winch (FIG. 15). This component is used in applications where the weight is too much for direct human manipulation and added force is needed to raise substantial weight cargo.

Optional winch strap hook (33) may be but not limited to 3″ strap steel and is a hook which allows rapid connection of the winch to lever handle (20) (FIG. 15). This component allows for rapid addition or removal of the winch nylon strap from the lever guardrail (FIGS. 15, 20).

Optional vertical latch (29), vertical latch, may be but not limited to ¼″×1½″×45″ steel and two bolts on the extremes. This component allows for fixing the lever guardrail in a vertical position. One is used on each right and left post.

Optional 45 degree latch (30), 45 degree latch, may be but not limited to ¼″×1½″×51″ steel and one bolt on the lower end and one hole on the upper end. This component allows for fixing the lever guardrail in a 45-degree position for hanging items. One is used on each right and left post.

Optional table leg (31) table leg may be but not limited to ½″×3″×54″ steel cut on a water jet cutting machine. This component allows for converting the lever guardrail into a table type configuration. Multiple table leg (31) can be used for increased load bearing ability.

Optional auto-tarp (32) may be but not limited to any type of waterproof material such as canvas or plastic and attaches via lashes. This component allows for blanketing cargo items with much ease as since the lever guardrail simply descends upon the cargo upon latching.

Optional component common welds may replace all bolts and visa versa.

### DRAWINGS

### Reference Numberals in Drawings

X = forward frame
Y = lever guard rail ramp
Z1 = left hinge bolt
Z2 = right hinge bolt
Z1a = left integral hinge
Z2a = right integral hinge
1 = tonque/backbone
1a = safety latch bolt
1a1 = aluminum ball handle nut
1a2 = shaft
1a3 = interior stainless steel nut
1a4 = shank
1a5 = head
2 = left tube holder
2a = right tube holder
3 = left forward frame
4 = right forward frame
5 = right Torflex bolt holes
5a = left Torflex bolt holes
6 = right leaf spring shackles
6a = left leaf spring shackles
7 = right front forward frame
8 = left front forward frame
9 = rear hinge cross member
10 = trailer hitch
11 = axle and wheels
12 = left lever arm
12a = left knee joint
13 = left ramp frame
14 = left suspension tube
15 = left post
16 = right lever arm
16a = right knee joint
17 = right post
18 = right suspension tube
19 = right ramp frame
20 = lever handle
21 = safety mount
22 = safety latch
23 = tail lights
24 = tread bright aluminum
25 = floor support
26 = Torflex axle
27 = leaf spring axle
28 = main body shipping profile
28a = one piece forward frame
29 = vertical latch
30 = 45 degree latch
31 = table leg
32 = auto-tarp
33 = winch strap hook
34 = winch

What is claimed is:

1. In a trailer of the type comprising a means of mass produced modular components wherein is a streamlined levered ramp, the improvement wherein said trailer members have a predetermined objective.

2. In a trailer of claim 1 wherein modular component members consist of off the shelf materials with predetermined holes such that assembly is simple, without welding, and functionality is allowed.

3. The trailer of the type comprising a forward frame made up of modular component members with predetermined holes whereby forming an integral hinge structure and latch point.

4. The trailer of claim 3 wherein said integral hinges are formed up from assembly of modular component members, which are specifically positioned to allow unobstructed rotation of ramp.

5. The trailer of claim 3 wherein said latch point is specifically designed to work in conjunction with the safety latch assembly.

6. A trailer of the type comprising a lever guard rail ramp made up of modular component members with predetermined holes whereby forming a hinge point, safety latch and latch point, right and left side knee joint posts and suspension tubes, suspended streamlined active ramp floor and levered guard rail.

7. A trailer of claim 6 wherein said lever guardrail ramp is fastened at the integral hinges and safety latch point of the forward frame.

8. A trailer of claim 6 wherein the lever guard rail acts as a lever.

9. A trailer of claim 6 wherein said active ramp floor has a turned up lip.

10. A trailer of claim 6 wherein the lever guard rail ramp acts as a ramp and also extended floor of the forward frame and extends to the rear aligned and in plane with the trailer forward frame and is suspended at the extreme active ramp floor end lip through suspension tubes which add usable weight supporting floor.

11. A trailer of claim 6 wherein said lever guard rail ramp forward holes are respectfully predetermined pivotally to coincide with the integral hinge structure for unobstructed pivoting of the active ramp floor.

12. A trailer of claim 6 wherein said latch mount position on the lever guard rail is predetermined just outside the front end of the forward frame in line with the exterior left vertical wall of the tongue/backbone further including the fastened safety latch and is adjustable with the safety mount by the dual holes for alignment with the safety latch bolt.

13. A trailer of claim 6 wherein said lever guard rail uses a humpback design so as to create a higher suspension position for suspension of the active ramp floor so as to increase the load bearing capacity of the rear ramp.

14. A trailer of claim 6 wherein said lever guard rail ramp latches and unlatches by use of the safety latch double catch system comprising a safety latch which forces users to judge the weight of cargo on the ramp before unlatching and also allows for easy operation when latching.

15. A trailer of claim 6 wherein said safety latch provides structural support of lever guard rail ramp by fixing the ramp in horizontal position thereby receiving upward forces translated through ramp to the lever guard rail to safety latch and to the tongue/backbone and vice versa.

16. A trailer of claim 6 wherein said trailer has no common latches to retain, sustain, and use the ramp. The forward safety latch firmly latches the ramp in one simple operation.

17. A trailer of claim 6 wherein said lever guardrail ramp pivotally rotates to allow lowering of the ramp to the ground and visa versa.

18. A trailer of claim 6 wherein said lever guard rail detaches from the ramp and is used in conjunction with special optional latching tools for fixing positions of the lever guard rail in various positions.

19. A trailer of claim 6 wherein said lever guard rail detaches from the ramp and knee joint posts move forward and down over forward frame which allows ramp to rotate forward over front frame flooring for vertical storage.
